(19) United States
(12) Patent Application Publication
(10) Pub. No.: US 2002/0112782 A1
(43) Pub. Date: Aug. 22, 2002

(54) Method and unit for cutting a log cant

(76) Inventor: Georges L. Brun, Saint Didier Au Mont D' Or (FR)

Correspondence Address: OLIFF & BERRIDGE, PLC, P.O. BOX 19928, ALEXANDRIA, VA, 22320, US

(21) Appl. No.: 10/062,406

(22) Filed: Feb. 5, 2002

(30) Foreign Application Priority Data
Feb. 16, 2001 (FR) 01 02188

(51) Int. Cl. B27M 1/08; B27L 5/02; B27L 7/00; B27C 9/00

(52) U.S. Cl. 144/369

(57) ABSTRACT

The present invention relates to a method for cutting a cant (5) from a log (4), consisting in:

a) measuring and recording the profile and dimensions of the log (4);

b) fixing the log (4) at its longitudinal ends between two spikes (20) of a carriage (14) that can move along a runway path (16);

c) positioning cutting tools (22, 24) and saw blades (26) according to the data measured and recorded at (a);

d) moving the log (4) into a cutting unit comprising the cutting tools (22, 24) and the saw blades (26), making at least one pass so as to cut the cant (5) from the log (4).

This method consists in performing the following sequence of steps:

e) parting off, from each side of the log (4), end planks (32) so as to obtain two flat base surfaces (4a) on the said log (4);

f) making a cut (34) along each longitudinal edge of the base surfaces (4a);

g) and parting off, from each side of the log (4), a first plank (38) of rectangular cross section, the thickness of which corresponds to the depth of cut (34).

### BACKGROUND OF THE INVENTION

The present invention relates to machines or units for cutting wood which are used in particular in sawmills. These units make it possible, starting from logs, firstly to cut a cant and, secondly, to cut the said cant into finished planks.

Logs generally have a somewhat frustoconical or uniform longitudinal shape. It is therefore important to optimize the size of the cant which will be cut from this log, so as to minimize the unusable waste.

### DESCRIPTION OF THE PRIOR ART

Cutting units that allow the implementation of a method consisting in:

measuring and recording the profile and dimensions of the log;

fixing the log at its longitudinal ends between two spikes of a carriage that can move along a runway path;

positioning cutting tools and saw blades according to the data measured and recorded; and

moving the log into a cutting unit comprising the cutting tools, making at least one pass so as to cut the cant from the log, are known.

Cutting units are known, for example, from document FR 2 499 449 in the name of the applicant. That document describes a unit comprising a double spike carriage which can be moved longitudinally along a runway path over two saws so as to move roundwood with regard to the saws.

Also known, from document FR 1 464 383, is a log sawmill comprising a log holder device supported by a monorail and able to move along the latter. The log holder device allows the said logs to be moved with regard to one or more saw blades, for example blades placed one after the other in the sawing line, so that several saw cuts can be made in a log in just one pass through the sawmill. The log holder device comprises for this purpose vertical suspension arms, the lower ends of which engage the end surfaces of the log placed in the sawing line.

The disadvantage with such cutting units often lies in the need for the offcuts parted off from the log cant to be picked up in special units or machines so that they can be sold.

The object of the present invention is aimed at avoiding specific cutting or treatment of the peripheral parts cut off during the cutting of the cant from the log.

Another object of the present invention is aimed at minimizing the log cutting operations when cutting the cant therefrom.

Another object of the present invention is aimed at positioning the cutting tools in an optimum fashion so as to cut a uniform cant, the dimensions of which are optimized with regard to the shape and dimensions of the said log.

### SUMMARY OF THE INVENTION

According to the invention, this method of cutting a cant from a log consists in performing the following sequence of steps:

parting off, from each side of the log, end planks so as to obtain two flat base surfaces on the said log;

making a cut along each longitudinal edge of the base surfaces;

and parting off, from each side of the log, a first rectangular plank, the thickness of which corresponds to the depth of the cut.

According to the invention, the cutting unit for implementing the aforementioned method comprises:

a runway path,

a carriage that can move along this runway path and is provided with spikes for catching the longitudinal ends of the log;

cutting tools comprising at least two chippers, at least two pairs of cutters (shapers), and at least two saw blades;

optoelectronic means for measuring and recording the profile and dimensions of the log;

means for positioning the cutting tools with regard to the path of the carriage;

and a control unit for driving the positioning means on the basis of data from, in particular, the optoelectronic means.

The invention will be better understood with the aid of the description which follows with reference to the appended schematic drawing which, by way of example, depicts one embodiment of the cutting unit for implementing the method for cutting a cant from a log, in which drawing:

### BRIEF DESCRIPTION OF THE DRAWINGS

FIG. 1 is a front view of one embodiment of a cutting unit according to the invention;

FIGS. 2 and 3 are schematic views illustrating the cutting method according to the invention;

FIGS. 4 to 10 depict, in succession, the shape of a cross section of the log during the cutting process according to the invention;

FIGS. 11 to 14 schematically depict additional steps in the method of cutting a log cant.

### DESCRIPTION OF THE PREFERRED EMBODIMENTS

The cutting unit according to the invention comprises a feed chain 2 for conveying a log 4 to the cutting unit. This log 4 is thus brought to a chain-driven drive 6 allowing the said log 4 to be rotated about its longitudinal axis 8.

An optoelectronic means 10 positioned facing the pivoting device 6 makes it possible to determine the profile and dimensions of the log 4 as it rotates on itself. The optoelectronic means 10 consist, for example, of a scanner with a head emitting/receiving a signal which can scan an area at least as wide as the diameter of the log 4.

The cutting unit also comprises a carriage 14 that can move on a runway track 16 and that supports arms 18. These arms have a spike 20 for catching the log 4 at their ends, on the one hand, and have variable spacing so that they can be adapted to fit the length of the said logs 4.

When the spikes 20 are fixed against each longitudinal edge of the log 4, the arms 18 are immobilized by any known means, so as to support the said log 4 and be able to move it into the cutting unit along a path which is preferably straight. The spikes 20 are advantageously positioned roughly at the center of the longitudinal ends of the logs 4.

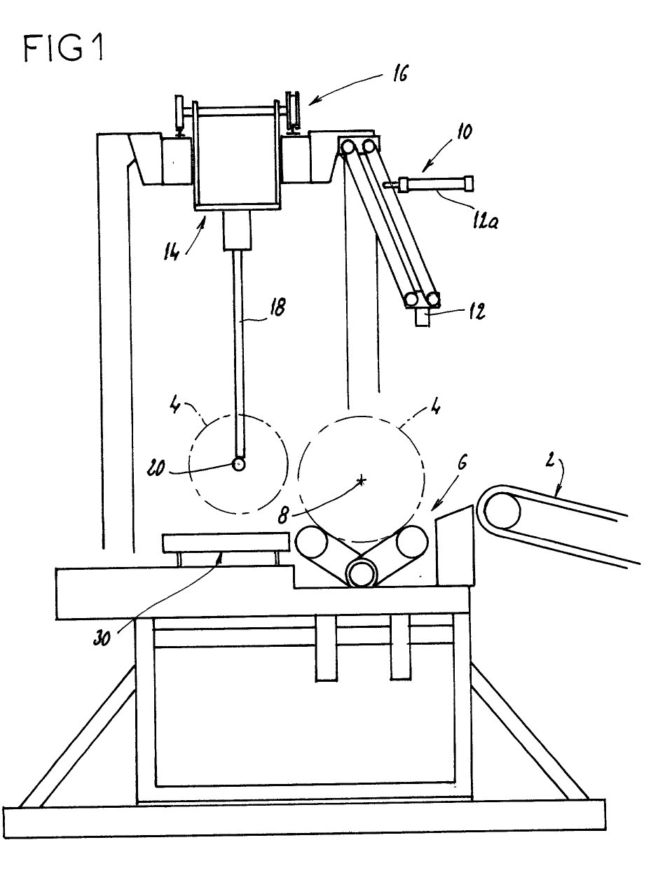

FIG. 1 shows an example in which a log 4 is in the process of being analyzed by the optoelectronic means 10 and another log 4 of smaller diameter engaged on the arms 18 via the spikes 20.

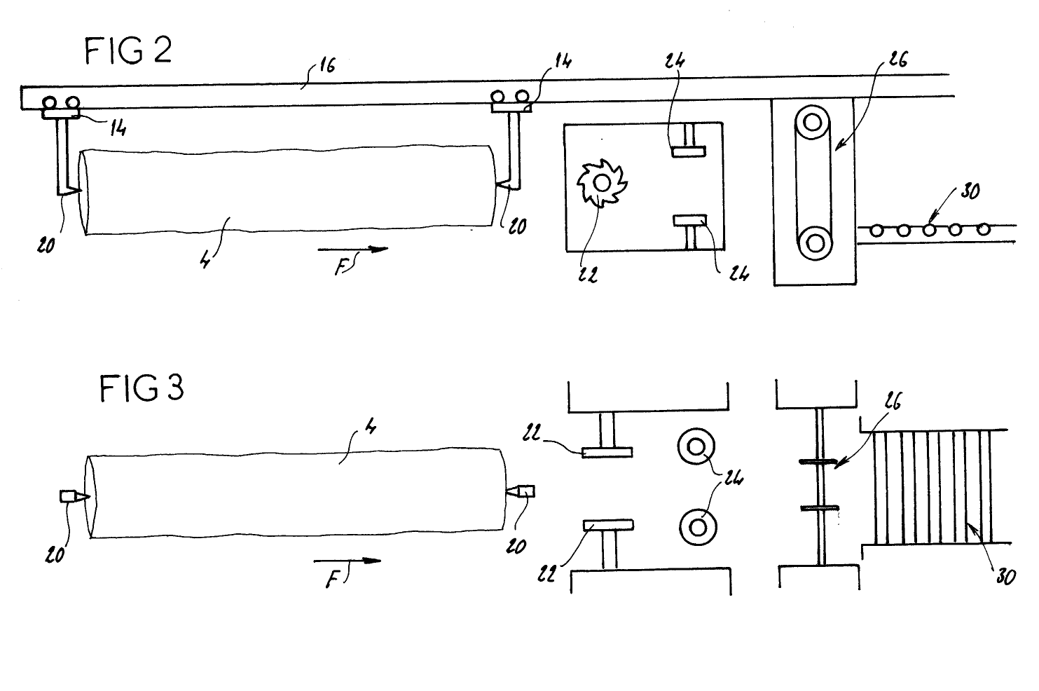

FIG. 2 is, for example, a side view of the cutting unit according to the invention. This figure is a schematic view in cross section and therefore shows only some of the functional elements. The cutting tools 22, 24 comprise at least two chippers 22, just one of which is depicted in side view, and at least two pairs of cutters 24 which may also be termed “shapers”, one of the said pairs being depicted. The axis about which the cutters 22 rotate is orthogonal to the axis of rotation of the chipper 22. The means driving the chipper 22 and the cutters 24 are not depicted.

The cutting unit also comprises means, not depicted, of positioning the cutting tools 22, 24 and the saw blades 26 with regard to the path of the carriage 14, and therefore of the log 4. This path is depicted schematically by the arrow “F”. The cutting unit also comprises a pair of saw blades 26, for example a bandsaw or circular saw, whose position depends on the position of the cutting tools 22, 24 and the saw blades 26 so as to delimit the cant 5 of the log 4 as the latter passes.

The cutting unit according to the invention also comprises a control unit for driving the means of positioning the cutting tools 22, 24 and the saw blades 26 according to data from, in particular, the optoelectronic means 10. The means of driving the saw blades 26 are not depicted. When the cant of the log 4 is cut, this cant is conveyed and deposited on a series of parallel transverse rollers 30 so that the said cant 5 can be moved along once it has been released from the spikes. The cant can thus be moved towards an additional cutting unit, for example a unit for cutting the said cant 5 into planks or diverted for any other use or treatment. This additional unit comprises an additional set of saw blades, which has not been depicted and which is intended to cut the cant 5 into planks.

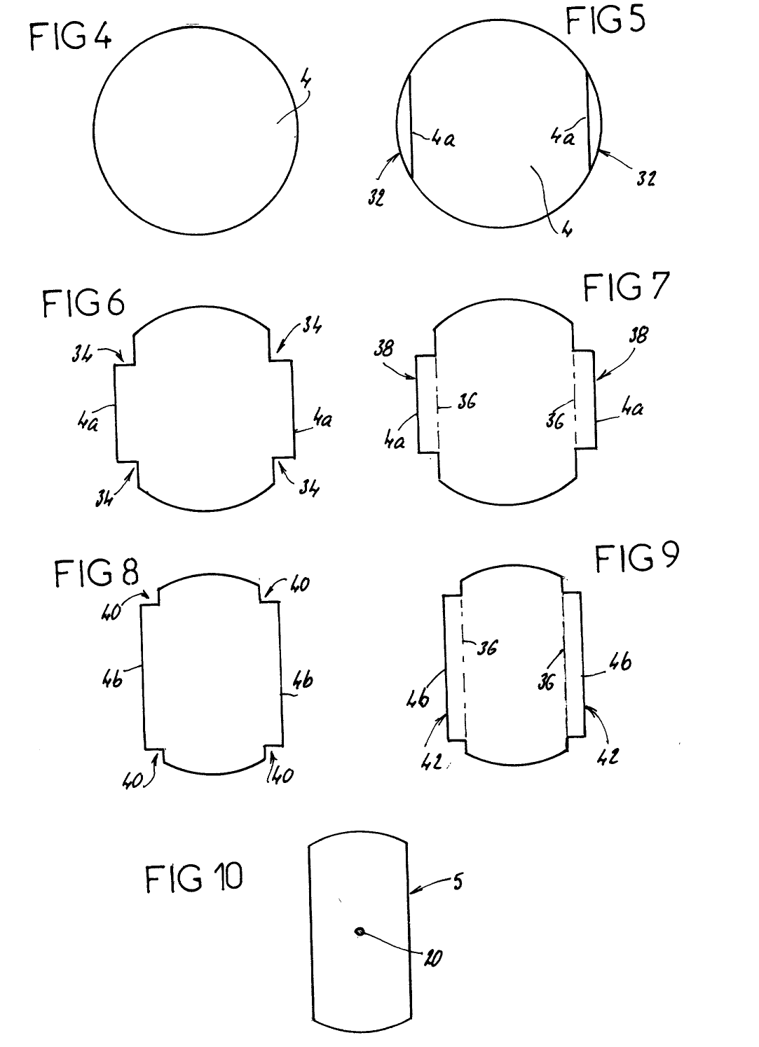

The way in which the cutting unit according to the invention works will be better understood with the description of the cutting method according to the invention supported by FIGS. 4 to 10.

The method of cutting the cant 5 from a log 4 consists in measuring and recording the profile and dimensions of the log 4. The latter is then fixed at its longitudinal ends between two spikes 20 of the carriage 14 that can move along the runway path 16. The cutting tools 22, 24 and the saw blades 26 are positioned according to the measured and recorded data relating to the profile and dimensions of the log 4. The latter is then moved through the cutting unit, making at least one pass, so as to cut the cant 5.

FIG. 4 depicts the log 4 before the cutting tools 22, 24 go to work on it.

According to the method according to the invention, end planks 32 are parted off by the slicers 22 on each side of the log 4, so as to obtain two flat base surfaces 4a on the said log 4. The log 4 then continues its path towards the cutters 24, which make a cut 34 along each longitudinal edge of the flat base surfaces 4a. Continued travel of the log 4 allows it then to arrive at the saw blades 26, which part off, on each side of the said log 4, a first plank of rectangular cross section, the thickness of which corresponds to the depth of the cut 34. This shaping and cutting work is depicted in FIGS. 6 and 7 respectively.

The positioning of the saw blades 26 is shown schematically in chain line 36. This positioning automatically takes account of the cutting width of the saw blades 26.

This then yields the cant 5 (cf. FIG. 10) with, as the only waste product, the end planks 32 parted off from the log 4 by the chipper 22. The first plank 38 has a perfectly rectangular cross section and can be sold on directly.

According to another embodiment of the method according to the invention, immediately after the first plank 38 has been parted off, an additional cut 40 is made along each longitudinal edge of the flat surfaces 4b obtained on the log 4 after the first planks 38 have been parted off.

The method then consists in parting off, on each side of the log 4, a second plank 42 of perfectly rectangular cross section and the thickness of which corresponds to the depth of the additional cut 40. This parting-off using the blades 26 is also depicted in chain line 36 in FIG. 9.

Ultimately, there is obtained the cant 5 as depicted in FIG. 10 and, at the same time without treatment or additional cutting, four planks 38-42 with perfectly rectangular cross sections. The cutting of the cant 5 from the log 4 therefore generates only a minimum of waste and consequently optimizes the yield of such a log 4. It is particularly advantageous to be able to use additional cuts 40 when the log 4 is of a large size.

The method according to the invention with additional cuts 40 can be obtained by passing the log 4 through the cutting unit a second time, with the cutters 24 and the blades 26 repositioned.

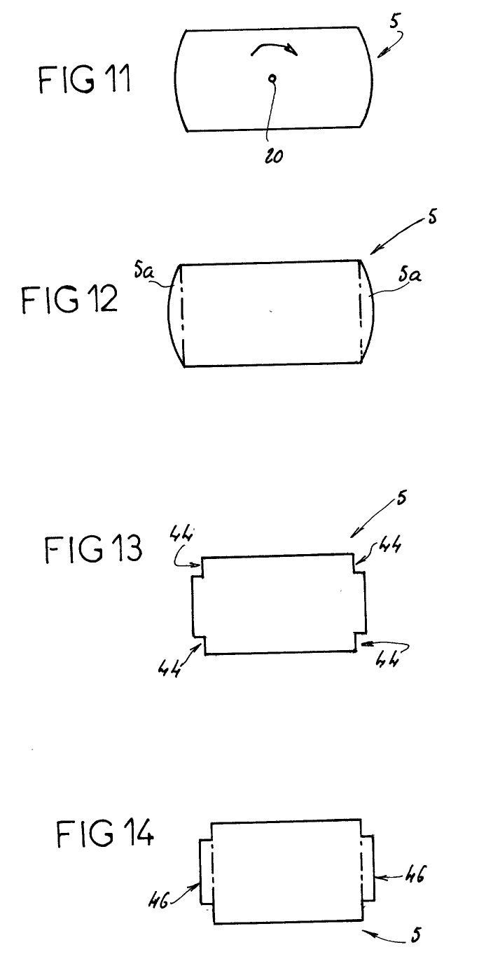

The spike system allows the cant 5 to be turned through a quarter of a turn (cf. FIG. 11) and allows the cutting of the log 4 to continue using the same method according to FIGS. 12, 13 and 14. For this, the chippers 22 are used to make the ends 5a of the cant 5 flat, and the cutters 24 are used to make additional cuts 44. Two additional rectangular planks 46 are then cut, by virtue of the repositioning of the blades 26 (depicted in chain line). The method according to the invention therefore makes it possible to obtain a perfectly rectangular or square cant 5.

1. A method of cutting a cant from a log, consisting in:
a) measuring and recording the profile and dimensions of the log;
b) fixing the log at its longitudinal ends between two spikes of a carriage that can move along a runway path;
c) positioning cutting tools and saw blades according to the data measured and recorded at (a);
d) moving the log into a cutting unit comprising the cutting tools and the saw blades, making at least one pass so as to cut the cant from the log;
which method consists in performing the following sequence of steps:
e) parting off, from each side of the log, end planks so as to obtain two flat base surfaces on the said log;
f) making a cut along each longitudinal edge of the base surfaces;
g) and parting off, from each side of the log, a first plank of rectangular cross section, the thickness of which corresponds to the depth of the cut.

2. The method as claimed in claim 1, which consists in:
h) making an additional cut along each edge of the flat surfaces obtained on the log in step (g);
i) and in parting off, from each side of the log, a second plank of rectangular cross section, the thickness of which corresponds to the depth of the additional cut.

3. The method as claimed in claim 1 or 2, which consists in performing steps (a) to (g) in a single pass through the cutting unit.

4. The method as claimed in claim 2, which consists in performing steps (h) and (i) during a second pass of the log through the cutting unit.

5. The method as claimed in claim 2, which consists in performing steps (a) to (i) in a single pass through the cutting unit.

6. A cutting unit for implementing the method as claimed in any one of claims 1 to 5, comprising:
a roughly horizontal runway path,
a carriage that can move along this runway path and is provided with spikes for catching the longitudinal ends of the log;
cutting tools comprising at least two chippers, at least two pairs of cutters (shapers), and at least two saw blades;
optoelectronic means for measuring and recording the profile and dimensions of the log;
means for positioning the cutting tools and the saw blades with regard to the path of the carriage;
and a control unit for driving the positioning means on the basis of data from, in particular, the optoelectronic means.

7. The cutting unit as claimed in claim 6, which is associated with an additional unit comprising a set of additional saw blades intended to cut the cant of the log into planks.

8. The cutting unit as claimed in claim 7, wherein the additional unit comprises a series of parallel transverse rollers for moving the cant of the log along once it has been released from the spikes so that it can be cut.

9. The cutting unit as claimed in any one of claims 6 to 8, wherein the cutting tools and the saw blades are arranged in such a way that the chippers, the cutters (shapers) and the saw blades meet the log in that order.
